(19) United States
(12) Patent Application Publication
(10) Pub. No.: US 2026/0164156 A1
(43) Pub. Date: Jun. 11, 2026

(54) Vehicle Mirror Speaker Device

(71) Applicants: Clark Tucker, Hayward, CA (US); Tung Giang Dao, Hayward, CA (US)

(72) Inventors: Clark Tucker, Hayward, CA (US); Tung Giang Dao, Hayward, CA (US)

(21) Appl. No.: 19/177,741

(22) Filed: Apr. 14, 2025

Related U.S. Application Data
(60) Provisional application No. 63/730,485, filed on Dec. 11, 2024.

(51) Int. Cl. H04R 1/02; B60R 1/06; B60R 1/12; B62J 29/00; B62J 43/30; B62J 45/10; H02S 20/30; H04R 3/00

(52) U.S. Cl. CPC H04R 1/028; B62J 29/00; B62J 43/30; B62J 45/10; H02S 20/30; H04R 1/025; H04R 3/00; B60R 1/06; B60R 1/12; B60R 2001/1276; H04R 2420/07; H04R 2499/13

(57) ABSTRACT

A vehicle mirror speaker device is provided. The device is comprised of a weather-resistant mirror housing with a mirror. The mirrored, reflective member features micro-perforations that allow sound transmission from at least one speaker positioned behind the mirror within the housing while preserving reflective properties. The speaker may further be positioned within an acoustic chamber in the housing designed to optimize sound clarity and directional projection. A wireless communication module enables Bluetooth connectivity, while a wired connection embodiment allows integration with existing vehicle audio systems. The device may be powered via a direct vehicle battery connection, or an optional solar charging panel may supplement power needs.

### CROSS-REFERENCE TO RELATED APPLICATION

The present application claims priority to, and the benefit of, U.S. Provisional Application No. 63/730,485, which was filed on Dec. 11, 2024, and is incorporated herein by reference in its entirety.

### FIELD OF THE INVENTION

The present invention relates generally to the field of vehicle speakers. More specifically, the present invention relates to a vehicle side mirror with at least one speaker positioned behind the mirrored, reflective member. Accordingly, the present disclosure makes specific reference thereto. Nonetheless, it is to be appreciated that aspects of the present invention are also equally applicable to other like applications, devices, and methods of manufacture.

### BACKGROUND

Motorcycle (and other vehicle) riders often lack an effective means to listen to music while traveling. Traditional solutions, such as external speakers mounted on the motorcycle, present challenges related to theft, exposure to environmental conditions, and potential damage from debris or accidents. Additionally, helmet-based audio systems can be expensive and may not always provide the desired audio quality or comfort. Riders who wish to enjoy music on their journeys must often rely on inadequate or inconvenient alternatives, such as using personal earbuds, which can raise safety concerns by reducing situational awareness. Without a secure and practical audio system, motorcyclists may experience less enjoyable rides, particularly on long-distance trips where music or other audio content could enhance the overall experience. Furthermore, external audio solutions that are not designed for motorcycles may struggle to project sound effectively due to interference from wind and road noise. This creates a need for an integrated, durable, and theft-resistant speaker system that allows motorcyclists to listen to audio content while maintaining their ability to hear surrounding traffic sounds.

Therefore, there exists a long-felt need in the art for a vehicle mirror speaker device that provides an integrated audio solution within a vehicle side mirror to prevent theft and damage. There also exists a long-felt need in the art for a vehicle mirror speaker device that ensures optimal audio output while maintaining the structural integrity and reflective properties of the mirror assembly. Moreover, there exists a long-felt need in the art for a vehicle mirror speaker device that offers a weather-resistant and wireless audio solution, reducing dependency on external mounting and minimizing interference from environmental factors.

The subject matter disclosed and claimed herein, in one embodiment thereof, comprises a vehicle mirror speaker device. The device is comprised of a weather-resistant mirror housing with a mirror. The mirrored, reflective member features micro-perforations that allow sound transmission from at least one speaker positioned behind the mirror within the housing while preserving reflective properties. The speaker may further be positioned within an acoustic chamber in the housing designed to optimize sound clarity and directional projection. A wireless communication module enables Bluetooth connectivity, while a wired connection embodiment allows integration with existing vehicle audio systems. The device may be powered via a direct vehicle battery connection, or an optional solar charging panel may supplement power needs.

In this manner, the vehicle mirror speaker device of the present invention accomplishes all the foregoing objectives and provides a speaker system integrated directly into the side mirror assembly of a motorcycle, scooter, UTV, or ATV. In doing so, the device maintains the full functionality of the mirror while incorporating micro-perforations that allow sound transmission without compromising visibility. Because the speaker system is enclosed within a durable, weather-resistant housing the device remains protected against environmental conditions. The inclusion of a wireless communication module enables seamless connectivity with smartphones and other devices, allowing riders to play audio content without additional wiring complications. By addressing concerns related to theft, audio quality, and environmental resistance, this invention provides a practical and efficient solution for motorcyclists seeking an integrated and secure speaker system.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle mirror speaker device. The device integrates a speaker into the rearview or side mirror assembly of motorcycles, scooters, UTVs, and ATVs. As a result, the device provides audio output while preserving the mirror's functionality and structural integrity in a compact and durable design suitable for various environmental conditions.

The device is comprised of a weather-resistant mirror housing. The mirrored, reflective member includes micro-perforations that allow sound transmission from a speaker positioned behind the mirrored, reflective member within the housing. The perforations may be arranged in various patterns to optimize acoustic performance while ensuring clear visibility. In one embodiment, the speaker is positioned within an acoustic chamber in the housing that is designed to enhance sound clarity and direct audio toward the rider, reducing interference from ambient noise.

A wireless communication module enables connectivity with external devices such as radios and smartphones via Bluetooth or other short-range transmission technologies. Alternatively, the speaker may be connected to the vehicle's audio system through a wired connection. The device may be powered via a direct connection to the vehicle battery with an in-line voltage regulator to ensure stable power delivery. In one embodiment, a solar charging panel is embedded within the mirror housing to supplement the power source.

A mounting bracket secures the device to the vehicle and includes an opening for attachment to a mounting post, arm, or other hardware such as bolts, screws, or clamps. The bracket may also feature an angle-adjustable design, allowing users to customize the mirror's positioning for optimal visibility and sound projection.

Accordingly, the vehicle mirror speaker device of the present invention is particularly advantageous as it provides a speaker system integrated directly into the side mirror assembly of a motorcycle, scooter, UTV, or ATV. In doing so, the device maintains the full functionality of the mirror while incorporating micro-perforations that allow sound transmission without compromising visibility. Because the speaker system is enclosed within a durable, weather-resistant housing the device remains protected against environmental conditions. The inclusion of a wireless communication module enables seamless connectivity with smartphones and other devices, allowing riders to play audio content without additional wiring complications. By addressing concerns related to theft, audio quality, and environmental resistance, this invention provides a practical and efficient solution for motorcyclists seeking an integrated and secure speaker system. In this manner, the vehicle mirror speaker device overcomes the limitations of existing vehicle speaker systems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle mirror speaker device of the present invention in accordance with the disclosed architecture;

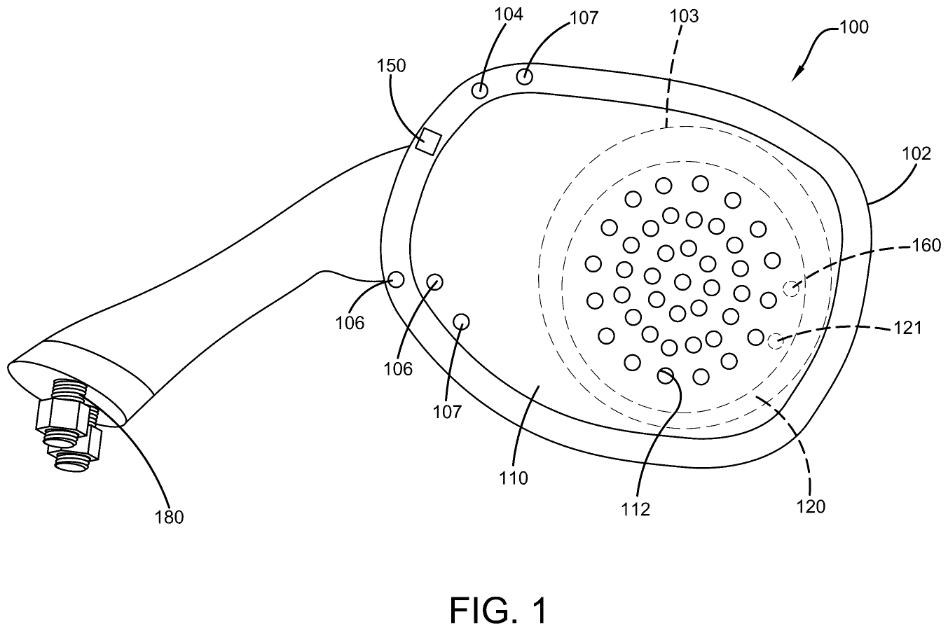

FIG. 2 illustrates a flowchart of a method of using one potential embodiment of a vehicle mirror speaker device of the present invention in accordance with the disclosed architecture.

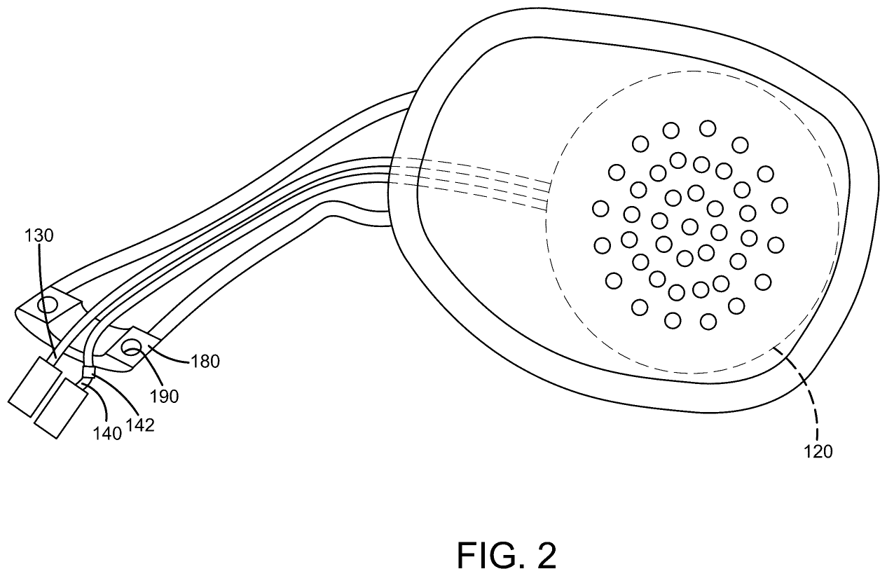

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle mirror speaker device that provides an integrated audio solution within a vehicle side mirror to prevent theft and damage. There also exists a long-felt need in the art for a vehicle mirror speaker device that ensures optimal audio output while maintaining the structural integrity and reflective properties of the mirror assembly. Moreover, there exists a long-felt need in the art for a vehicle mirror speaker device that offers a weather-resistant and wireless audio solution, reducing dependency on external mounting and minimizing interference from environmental factors.

The present invention, in one exemplary embodiment, is comprised of a vehicle mirror speaker device. The device incorporates a speaker into the rearview or side mirror assembly of motorcycles, scooters, UTVs, and ATVs, providing audio output while preserving the mirror's functionality and structural integrity. Its compact and durable design ensures suitability for various environmental conditions.

The device is comprised of a weather-resistant mirror housing, with a mirrored, reflective member featuring micro-perforations that allow sound transmission from a speaker positioned behind the mirror within the housing. These perforations may be arranged in various patterns to optimize acoustic performance while maintaining clear visibility. In one embodiment, the speaker is enclosed within an acoustic chamber designed to enhance sound clarity and direct audio toward the rider, minimizing interference from ambient noise.

A wireless communication module enables connectivity with external devices such as radios and smartphones via Bluetooth or other short-range transmission technologies. Alternatively, the speaker may be wired to the vehicle's audio system. The device may be powered through a direct connection to the vehicle battery, incorporating an in-line voltage regulator for stable power delivery. In one embodiment, a solar charging panel is embedded within the mirror housing to supplement the power source.

A mounting bracket secures the device to the vehicle and includes an opening for attachment to a mounting post, arm, or other hardware such as bolts, screws, or clamps. The bracket may also feature an angle-adjustable design, allowing users to customize the mirror's positioning for optimal visibility and sound projection.

Therefore, the device provides an integrated speaker system within the side mirror assembly of a motorcycle, scooter, UTV, or ATV while maintaining full mirror functionality. Micro-perforations in the mirrored, reflective member facilitate sound transmission without compromising visibility. The speaker system is enclosed in a durable, weather-resistant housing to ensure protection against environmental conditions. A wireless communication module allows seamless connectivity with smartphones and other devices, enabling riders to play audio content without additional wiring. By addressing concerns related to theft, audio quality, and environmental resistance, this device offers a practical and efficient solution for motorcyclists seeking a secure and integrated speaker system, overcoming limitations found in existing vehicle speaker designs.

Referring initially to the drawings,

The vehicle mirror speaker device 100 is designed to integrate a speaker into a rearview and/or side mirror assembly of a motorcycle, scooter, utility terrain vehicle (UTV), or all-terrain vehicle (ATV). The device 100 is configured to provide audio output while maintaining the functionality and structural integrity of a mirror assembly. The design of the device 100 ensures that audio performance is optimized while maintaining a compact and durable form factor suitable for exposure to various environmental conditions.

The device 100 is comprised of a mirror housing 102 made from weather-resistant materials such as reinforced acrylonitrile butadiene styrene (ABS) plastic, polycarbonate composites, or aluminum alloy. These materials are selected for their impact resistance, durability, and ability to withstand prolonged exposure to environmental factors such as rain, dust, and temperature variations. The housing 102 may further be comprised of an anti-corrosion coating 104, which may include anodization, powder coating, or chemical treatments to protect against rust and oxidation. Additionally, a UV-resistant coating 106 may be applied to both the housing 102 and the mirrored, reflective member 110 to prevent degradation from extended exposure to sunlight, reducing the risk of discoloration, brittleness, or material weakening over time. To further enhance protection, the mirrored, reflective member 110 and housing 102 may be comprised of a weatherproof coating 107, which may be a hydrophobic and/or oleophobic coating that repels moisture, dirt, and debris, minimizing the accumulation of contaminants that could affect visibility or performance.

The mirrored, reflective member 110 is comprised of impact-resistant acrylic or polycarbonate and features micro-perforations/openings 112. The openings 112 allow sound waves to pass through the mirrored, reflective member 110 while preserving its reflective properties and structural integrity. The perforations 112 may be arranged in various patterns, such as a uniform grid, concentric circles, or a dispersed layout, to optimize acoustic performance while maintaining a clear and undistorted reflective surface. The size, shape, and distribution of the openings 112 may be configured to balance sound transmission efficiency with the need for high visibility, ensuring the rider experiences minimal distortion when viewing the mirror 110.

At least one speaker 120 is positioned behind the mirrored, reflective member 110 within the housing 102. The openings 112 in the mirrored, reflective member 110 facilitate audio transmission while minimizing distortion. The speaker 120 may be enclosed within an acoustic chamber 103 integrated into the housing 102. The acoustic chamber 103 is designed to enhance sound clarity by preventing muffling and optimizing directional audio projection. The geometry of the acoustic chamber 103 may be configured to direct sound primarily toward the rider, reducing interference from ambient noise such as wind and road sounds. The speaker 120 may be any type or combination of speaker designs, including, but not limited to, full-range speakers, tweeters, mid-range drivers, and subwoofers, depending on the desired audio performance. The positioning of the speaker 120 within the housing 102 may vary based on acoustic tuning requirements, ensuring the emitted sound remains clear, balanced, and audible even in high-noise environments. The materials used in the construction of the speaker 120 may be comprised of a water-resistant and/or waterproof coating 121 to protect against moisture ingress.

The device 100 is also comprised of a wireless communication module 160 configured to enable wireless audio connectivity with external devices such as radios, smartphones, and other smart devices. The module 160 may support standard wireless communication protocols, including Bluetooth and other short-range transmission technologies. In one embodiment, the speaker 120 may be in a wired connection via at least one wire 130 to an existing audio interface of the vehicle on which the device 100 is installed.

The device 100 is also comprised of a direct power connection via at least one wire 140 to the vehicle battery. The wire 140 may be comprised of an in-line voltage regulator 142 to ensure stable and safe power delivery, preventing electrical fluctuations that may damage internal components. The voltage regulator 142 may be configured to convert the vehicle's power supply to a suitable operating voltage for the speaker 120 and wireless communication module 160, ensuring consistent performance. In one embodiment, a solar charging panel 150 is embedded within the mirror housing 102. The solar charging panel 150 is configured to supplement the primary power source, providing auxiliary charging capabilities and reducing dependency on the vehicle's battery. The solar charging panel 150 may be comprised of a high-efficiency monocrystalline or polycrystalline photovoltaic solar panel capable of converting sunlight into electrical energy.

The device 100 is further comprised of a mounting bracket 180 configured to secure the device 100 to a vehicle. The mounting bracket 180 is comprised of an opening 190, allowing the device 100 to be affixed to a mounting post, arm, or other attachment point on the vehicle. The mounting bracket 180 may be constructed from corrosion-resistant materials such as stainless steel, anodized aluminum, or reinforced polymer composites to ensure durability in various environmental conditions. The opening 190 may be configured to accommodate different mounting hardware such as, but not limited to, bolts, screws, clamps, etc. The bracket 180 may also be comprised of an angle-adjustable bracket, enabling users to customize the positioning of the device 100 in at least one direction for optimal visibility and sound projection.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle mirror speaker device” and “device” are interchangeable and refer to the vehicle mirror speaker device 100 of the present invention.

Notwithstanding the foregoing, the vehicle mirror speaker device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle mirror speaker device 100 as shown in the FIGS. are for illustrative purposes only, and that many other sizes and shapes of the vehicle mirror speaker device 100 are well within the scope of the present disclosure. Although the dimensions of the vehicle mirror speaker device 100 are important design parameters for user convenience, the vehicle mirror speaker device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle mirror speaker device comprising:
a mirror housing;
a mirror attached to the mirror housing, the mirror comprised of an opening;
a speaker positioned within the mirror housing behind the mirrored, reflective member;
a wireless communication module;
a power connection configured to supply electrical power to the speaker and the wireless communication module; and
a mounting bracket.

2. The vehicle mirror speaker device of claim 1, wherein the mirror housing is comprised of a weather-resistant material comprised of a reinforced acrylonitrile butadiene styrene (ABS) plastic, a polycarbonate composites, or an aluminum alloy.

3. The vehicle mirror speaker device of claim 1, wherein the mirror housing is comprised of a UV-resistant coating.

4. The vehicle mirror speaker device of claim 1, wherein the mirror is comprised of a UV-resistant coating.

5. The vehicle mirror speaker device of claim 1, wherein the mirror housing is comprised of an anti-corrosion coating.

6. The vehicle mirror speaker device of claim 1, wherein the speaker is comprised of a water-resistant or a waterproof coating.

7. The vehicle mirror speaker device of claim 1, wherein the mounting bracket is comprised of an angle-adjustable bracket.

8. A vehicle mirror speaker device comprising:
a mirror housing;
a mirrored, reflective member attached to the mirror housing, the mirrored, reflective member comprised of an opening;
a speaker positioned within the mirror housing behind the mirrored, reflective member, wherein the speaker is positioned within an acoustic chamber configured to enhance a sound clarity and direct an audio from the speaker;
a wireless communication module;
a power connection comprised of a wire configured to supply electrical power to the speaker and the wireless communication module; and
a mounting bracket.

9. The vehicle mirror speaker device of claim 8, wherein the mounting bracket is comprised of an angle-adjustable bracket.

10. The vehicle mirror speaker device of claim 8 further comprised of a voltage regulator.

11. The vehicle mirror speaker device of claim 8, wherein the mirror housing is comprised of a UV-resistant coating.

12. The vehicle mirror speaker device of claim 8, wherein the mirror is comprised of a UV-resistant coating.

13. The vehicle mirror speaker device of claim 8, wherein the mirror housing is comprised of an anti-corrosion coating.

14. The vehicle mirror speaker device of claim 8, wherein the speaker is comprised of a water-resistant or a waterproof coating.

15. A vehicle mirror speaker device comprising:
a mirror housing;
a mirrored, reflective member attached to the mirror housing, the mirrored, reflective member comprised of an opening;
a speaker positioned within the mirror housing behind the mirrored, reflective member, wherein the speaker is positioned within an acoustic chamber configured to enhance a sound clarity and direct an audio from the speaker;
a wireless communication module;
a power connection comprised of a wire configured to supply electrical power to the speaker and the wireless communication module;
a solar panel; and
a mounting bracket.

16. The vehicle mirror speaker device of claim 15, wherein the mounting bracket is comprised of an angle-adjustable bracket.

17. The vehicle mirror speaker device of claim 15 further comprised of a voltage regulator.

18. The vehicle mirror speaker device of claim 15, wherein the solar panel is positioned on the mirror housing.

19. The vehicle mirror speaker device of claim 15, wherein the solar panel is comprised of a monocrystalline solar panel or polycrystalline photovoltaic solar panel.

20. The vehicle mirror speaker device of claim 15, wherein the speaker is comprised of a water-resistant or a waterproof coating.
